(19) United States
(12) Patent Application Publication
(10) Pub. No.: US 2012/0050405 A1
(43) Pub. Date: Mar. 1, 2012

(54) PRINTING APPARATUS AND PRINTING METHOD

(75) Inventor: Tomohito Abe, Yokohama-shi (JP)

(73) Assignee: CANON KABUSHIKI KAISHA, Tokyo (JP)

(21) Appl. No.: 13/195,443

(22) Filed: Aug. 1, 2011

(30) Foreign Application Priority Data
Aug. 27, 2010 (JP) 2010-191385

(51) Int. Cl. B41J 23/00

(52) U.S. Cl. 347/37

(57) ABSTRACT

A printing apparatus having: a carriage on which print heads including a first and a second print head are mounted, movable along a guide between a first and a second end; and a control unit to control the carriage reciprocation when printing is performed onto a print medium, wherein the print heads are so arranged that when the carriage locates at the first end, the first print head relatively apart from the guide is nearer print medium than the second print head relatively near the guide, and when the carriage locates at the second end, the second print head is nearer print medium than the first print head, and wherein a distance from the first print head to print medium when the carriage locates at the first end is greater than a distance from the second print head to print medium when the carriage locates at the second end.

### BACKGROUND OF THE INVENTION

1. Field of the Invention

The present invention relates to a printing apparatus and a printing method, and relates in particular to a technique for suppressing degradation of printing quality that is caused by vibration generated during the acceleration of a carriage on which a print head is mounted.

2. Description of the Related Art

It is well known that when a carriage on which a print head, such as inkjet print head, is mounted and reciprocally driven gains speed, vibration of the carriage occurs. Such vibration frequently occurs when an arrangement employs a guide member to both support the carriage and guide the movement of the carriage. With an arrangement that performs printing in a carriage acceleration region where such vibration occurs, vibration of a print head mounted on the carriage also occurs, and as a result, ink dots will be deposited at dispersed locations, and the printing quality would be degraded.

An example is disclosed in Japanese Patent Laid-Open No. 2001-179954, according to which an approach run distance, between a carriage stop position and a print start position, is increased to perform high quality printing, so that this distance is greater than the distance employed when normal printing is to be performed. As a result, a printing can be carried out under the condition that vibration of the carriage and vibration of the print head are satisfactorily attenuated, and degradation of the printing quality due to vibration is suppressed.

However, the arrangement described in Japanese Patent Laid-Open No. 2001-179954 cannot be employed for a printing apparatus that has been proposed, wherein to facilitate the performance of high-speed printing, a plurality of print heads, or nozzle arrays, for printing the same colors are arranged in a direction in which a printing medium is to be conveyed. That is, an effect produced by the aforementioned vibration associated with acceleration varies, depending on the plurality of print heads or the plurality of nozzle arrays mounted on the carriage. Furthermore, a print head or a nozzle array that is located further from the carriage guide member is more greatly affected by vibration, and therefore, the locations whereat ink dots are printed are more widely dispersed.

### SUMMARY OF THE INVENTION

In order to resolve the above described problem, one objective of the present invention is to provide a printing apparatus, and a printing method, for suppressing printing quality degradation that is caused by vibration, generated by an accelerated movement of a carriage, whereon a plurality of print heads are mounted and are located at different distances to a guide member.

To resolve the above described problem, a printing apparatus having: a carriage, on which a plurality of print heads including a first print head and a second print head are mounted, movable along a guide between a first end and a second end; and a control unit configured to control a reciprocation of the carriage when printing is performed onto a print medium, wherein the plurality of print heads are so arranged that when the carriage is located at the first end, the first print head, relatively apart from the guide, is positioned nearer the print medium than the second print head, located relatively near the guide, and when the carriage is located at the second end, the second print head is positioned nearer the print medium than the first print head, and wherein a distance from the first print head to the print medium when the carriage is located at the first end is greater than a distance from the second print head to the print medium when the carriage is located at the second end.

The present invention provides effects such that, even when vibration is generated by an accelerated movement of the carriage of an inkjet printing apparatus, wherein a plurality of print heads are mounted, degradation of the printing quality can be suppressed.

Further features of the present invention will become apparent from the following description of exemplary embodiments (with reference to the attached drawings).

### BRIEF DESCRIPTION OF THE DRAWINGS

FIG. 1 is a perspective exterior view of an inkjet printing apparatus for which the present invention can be applied;

FIG. 2 is a schematic diagram illustrating an arrangement pattern for print heads that are mounted on a carriage according to the present invention;

FIG. 3 is a block diagram illustrating a control configuration for the inkjet printing apparatus according to the present invention;

FIG. 4 is a flowchart showing the printing control performed by the present invention;

FIGS. 5A and 5B are diagrams showing the carriage at the scan start position, and a printing medium; and

FIG. 6 is a diagram showing a relationship between the scan distance of the carriage and the amplitude of vibration.

### DESCRIPTION OF THE EMBODIMENTS

The embodiments of the present invention will now be described in detail.

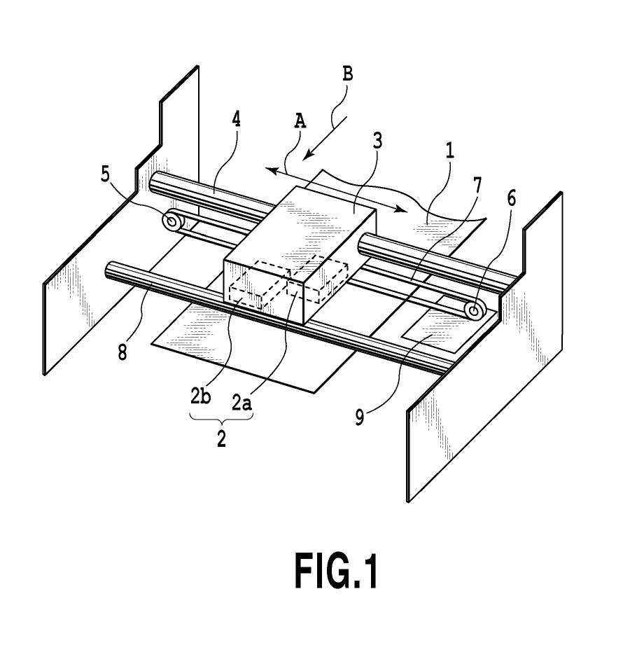

FIG. 1 is a perspective exterior view of the structure of a typical inkjet printing apparatus, applied for the embodiments of the present invention, in which are mounted print heads that eject ink droplets. As shown in FIG. 1, a plurality (two in the embodiments of this invention) of print heads 2 are mounted on a carriage 3 opposite a print medium 1, and the carriage 3 is rotatably and slidably guided and supported by a guide shaft 4 that serves as a guide member. A carriage motor 5 fitted with a pulley is arranged at one end of the movement range of the carriage 3, while an idle pulley 6 is located at the other end, and a timing belt 7 is extended between the pulleys, so that the carriage 3 and the timing belt 7 are linked to each other. In order to prevent the carriage 3 from pivoting at the guide shaft 4, a support member 8 is extended, parallel to the guide shaft 4, and supports the carriage 3 to slide freely along the guide shaft 4. Further, a head maintenance mechanism 9 that performs maintenance of the print heads 2 is located in a non-printing area where printing is not performed. The head maintenance mechanism 9 includes a capping device (not shown) for closing the openings of the nozzles of the print heads 2 during a non-printing period, and a wiper (not shown) for removing foreign substances and extra ink that are attached to the nozzle faces. With this arrangement, the carriage 3 reciprocates, in directions indicated by a double-headed arrow A (the main scan direction), along the axis of the guide shaft 4 between one end (the first end) and the other end (the second end). Further, a printing medium 1 is conveyed by a conveying motor (not shown) in a direction (the sub-scan direction) indicated by an arrow B, which intersects the direction (the main scan direction) in which the carriage 3 is moved.

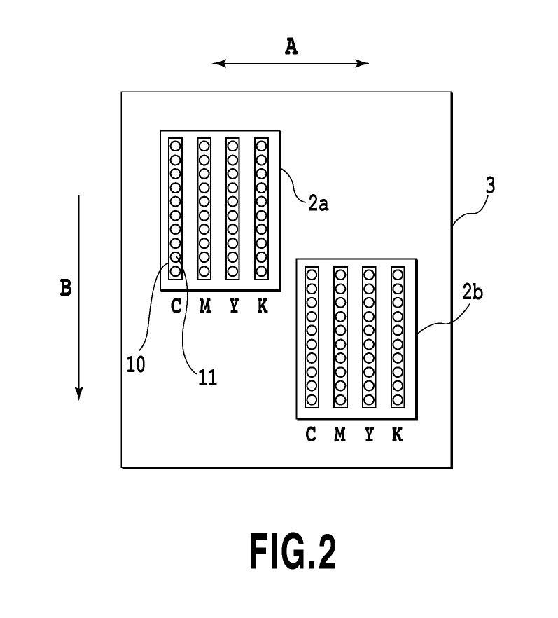

FIG. 2 is a schematic diagram showing an arrangement pattern for two inkjet heads (print heads 2a and 2b) that are mounted on the carriage 3. Nozzle arrays 10 for the individual colors CMYK (cyan, magenta, yellow and black) are formed for the print heads 2a and 2b. Each of the nozzle arrays 10 consists of a plurality of nozzles 11. According to the positional relationship between the adjacent print heads 2a and 2b, the print heads 2a and 2b partially overlap each other, as shown in FIG. 2, so that the nozzle arrays of the overlapped portions of the print heads 2a and 2b scan the same area. With this arrangement, even when the nozzle arrays 10 of the individual print heads 2a and 2b are short, printing can be performed by regarding these print heads 2a and 2b as a print head assembly, for which the length in the sub-scan direction is almost equal to the sum of the lengths of the two nozzle arrays of the print heads 2a and 2b. As a result, fast printing is enabled. At this time, for the nozzles by which the same area is to be scanned, half of the print data is allocated for each nozzle, and is employed for the ejection of ink through the nozzles.

According to the example shown in FIG. 2, the print heads 2a and 2b are separately mounted on the carriage 3; however, the present invention is not limited to this arrangement. The nozzle arrays for the print heads 2a and 2b may be formed together, as a single unit, and a single print head having a plurality of nozzles may also be provided.

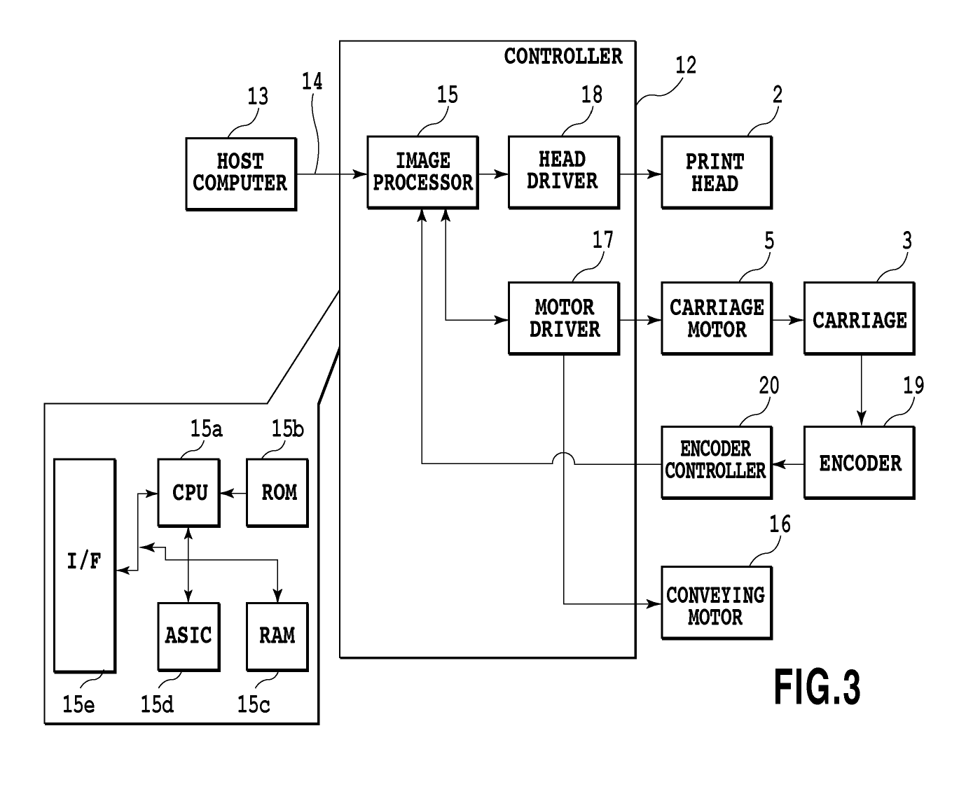

FIG. 3 is a block diagram illustrating the control configuration for the inkjet printing apparatus shown in FIG. 1. As shown in FIG. 3, the inkjet printing apparatus in FIG. 1 includes a controller 12, employed to control the entire apparatus, that is connected to a host computer (hereinafter referred to as a host) 13, via a cable 14, and operates the print heads 2 and a carriage motor 5. Instead of the cable 14, however, an infrared ray or a radio wave may be employed as an interface (e.g., IrDA or Bluetooth (trademarks)). The host 13 transmits print data, a printing mode type and various commands to the controller 12 via the cable 14. An image processor 15 is also provided for the controller 12, and includes a CPU 15a, for performing various processes to control the entire inkjet printing apparatus, a ROM 15b, used to store control programs that correspond to various processes, and a RAM 15c, used as a print buffer or a work area for performing a control program. The image processor 15 also includes an ASIC 15d, for performing various image processes, such as raster column conversion, and an interface (I/F) 15e, used to transmit data to and receive data from the host 13.

The controller 12 also includes a motor driver 17, for controlling the carriage motor 5 and a conveying motor 16, and a head driver 18 for driving the print heads 2. The carriage motor 5 is a motor that generates a driving force used to move the carriage 3 in the main scan direction, and the conveying motor 16 is a motor that generates a driving force for driving a feeding roller (not shown) and a discharge roller (also not shown) for conveying a printing medium. An encoder 19 is employed to detect the location of the carriage 3 in the main scan direction, and an output signal from the encoder 19 is transmitted as feedback to an encoder controller 20 and then to the CPU 15a of the image processor 15. The encoder controller 20 processes output signals from the encoder 19, and generates a carriage position signal and a carriage velocity signal. Therefore, the carriage position signal and the carriage velocity signal are transferred to the CPU 15a.

The embodiments of the printing control performed by employing the inkjet printing apparatus having the above described arrangement will now be described.

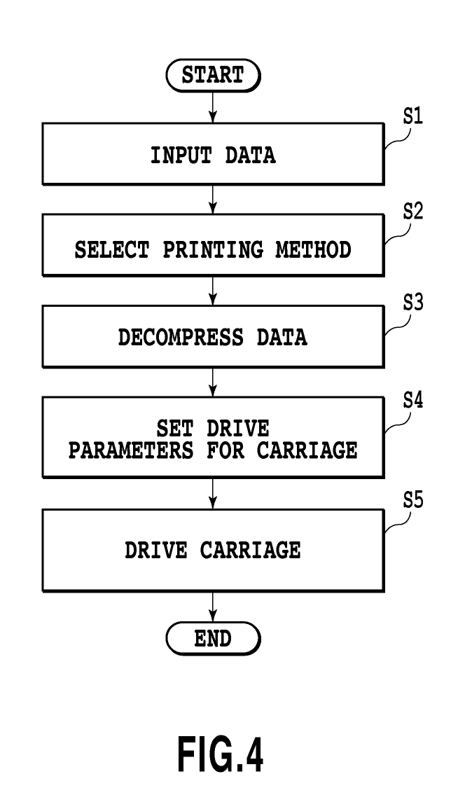

FIG. 4 is a flowchart showing the printing operation, including a carriage driving process, as a main operation.

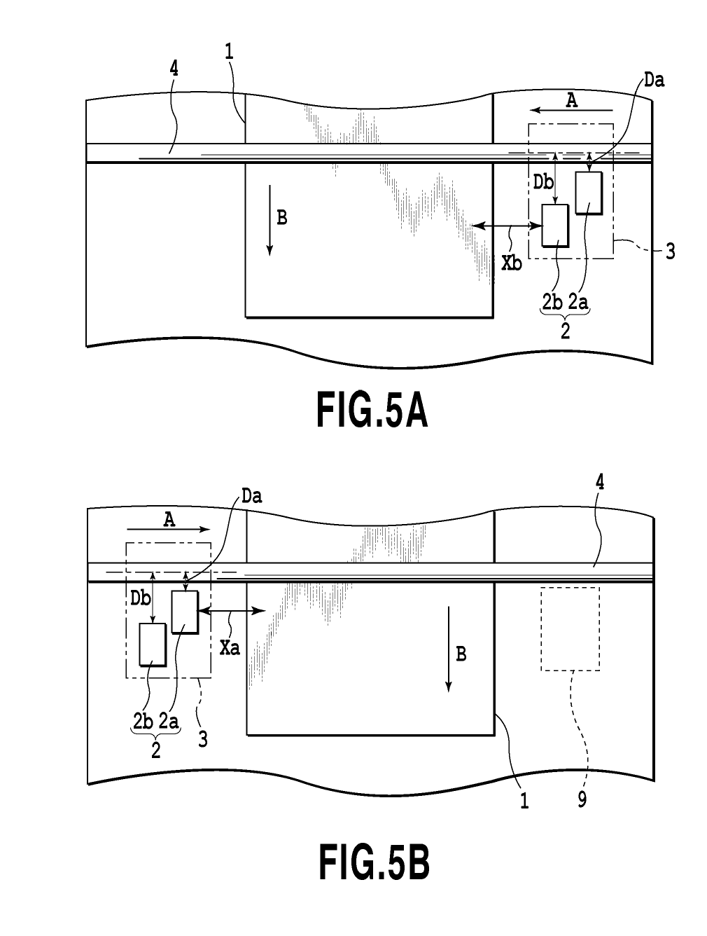

FIGS. 5A and 5B are schematic diagrams showing a positional relationship between the carriage 3, at the scan start position, and the printing medium 1 when printing starts. The scan start position in FIG. 5A is the position at which the carriage 3 is located before moving from right to left, in FIG. 5A, to perform printing (hereinafter, this direction is called the forward scan direction). The scan start position in FIG. 5B is the position at which the carriage 3 is located before moving from left to right, in FIG. 5B, to perform printing (hereinafter this direction is called the backward scan direction). Further, in the following explanation, it is assumed that the positional relationship shown in FIGS. 5A and 5B is established between the two print heads 2a and 2b mounted on the carriage 3. Specifically, according to the positional relationship of the print heads 2a and 2b, a distance Db from the guide shaft 4 to the print head 2b (the first print head) is greater than a distance Da from the guide shaft 4 to the print head 2a (the second print head) (Da<Db). In addition, when the carriage 3 is located near the right end, as shown in FIG. 5A, the print head 2b is located nearer the conveying path for the printing medium 1 than is the print head 2a in the main scan direction A. In this case, on the side near the left end in FIG. 5B, the print head 2a is located nearer the conveying path for the printing medium 1 than is the print head 2b in the main scan direction A.

The movement of the carriage 3 in this embodiment will now be described while referring to the flowchart in FIG. 4. First, when print data is received from the host 13 at step S1, the processing then advances to step S2 and a printing method is selected. Based on the print data, a printing mode is set by selecting either two-way printing, for performing printing both during the forward movement and the backward movement of the carriage 3, or one-way printing, for performing printing during the forward movement or the backward movement of the carriage 3 (the processes performed in these printing modes will be described later in detail). In this embodiment, it is assumed that two-way printing has been selected. At step S3, the controller 12 decompresses the input print data in the print buffer of the RAM 15c, and at step S4 sets the individual drive parameters for the carriage 3.

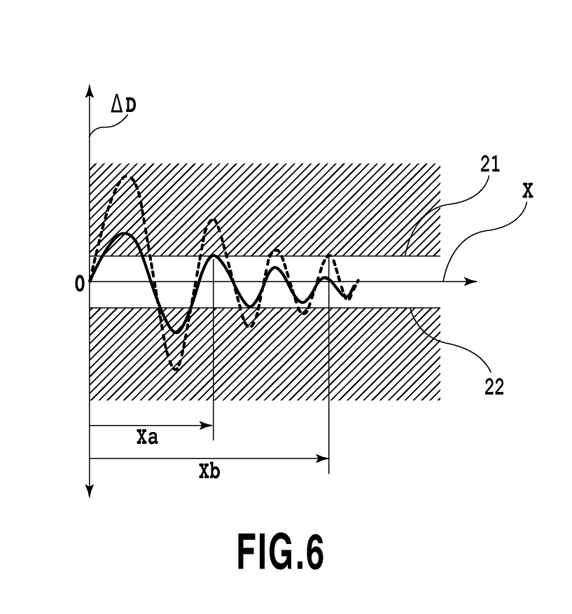

As one of the drive parameters for the carriage 3 of this embodiment, the setting of a distance in the main scan direction, between the scan start position of the carriage 3 and the print start position relative to the printing medium 1, will now be described while referring to FIGS. 5A and 5B and FIG. 6. At the scan start position, movement of the carriage 3 is accelerated by the application of a driving force in the main scan direction A. FIG. 6 is a waveform graph that represents, for the individual print heads 2a and 2b, an amplitude ΔD (the vertical axis) of vibration generated during the accelerated movement of the carriage 3, relative to a distance X (the horizontal axis) that the carriage 3 has traveled following the start of scanning. In FIG. 6, a solid line indicates the waveform of the print head 2a, and a broken line indicates the waveform of the print head 2b. The vibration shows a movement such that immediately after movement of the carriage 3 was accelerated the amplitude was greatly increased, and was attenuated thereafter. Border lines 21 and 22 along hatched areas in FIG. 6 indicate the limits of the vibration amplitude, and above the border line 21 or below the border line 22, printing quality, such as image quality, is adversely affected. As a result, when the amplitude of vibration becomes greater, this is visually identified as the degradation of an image. As shown in the waveform graph in FIG. 6, the vibration amplitude for the print head 2b, located apart from the guide shaft 4, is greater than the waveform amplitude for the print head 2a. When the carriage 3 moves in the forward scan direction, as shown in FIG. 5A, the print start timing is begun for the print head 2b before the print head 2a. When the carriage 3 moves in the backward scan direction, as shown in FIG. 5B, the print start timing is begun for the print head 2b before the print head 2a.

In this embodiment, when the acceleration for scanning is a predetermined rate, an approach run distance Xb for the print head 2b for printing in the forward scan direction is set greater than an approach run distance Xa for the print head 2a for printing in the backward scan direction. That is, as shown in FIG. 6, the approach run distances Xa and Xb of the print heads 2a and 2b are set so that the vibration amplitudes for the print heads 2a and 2b fall between the border lines 21 and 22. Then, positions obtained by shifting the scan start positions at the approach run distances of the print heads 2a and 2b are set as the print start positions for the print heads 2a and 2b.

Based on the drive parameters thus designated at step S4, the carriage 3 is driven at step S5.

Conventionally, when a plurality of print heads are employed to perform two-way printing, the approach run distances for a carriage in the forward scan direction and in the backward scan direction, and the associated print start positions are uniquely determined, and therefore, there is a possibility that printing will be started even though the amplitude of vibration has not yet been appropriately attenuated, especially for the print head that is located farther from the guide shaft. Further, since great approach run distances are prepared for the forward scan direction and the backward scan direction, there is another possibility that the moving distance for the carriage will have been extended, and as a result, the size of the apparatus will have been increased in the main scan direction. According to this embodiment, however, the approach run distance Xb of the print head, apart from the guide shaft 4, is set greater than the approach run distance Xa of the print head 2a, near the guide shaft 4. As a result, when printing, vibration of the print head located apart from the guide shaft has been appropriately attenuated, and as a result, high quality printing can be performed. Furthermore, a great approach run distance is required only on the right end side (first end side) shown in FIGS. 5A and 5B, and the approach run distance on the left end side (second end side) need not be extended, so that the size of the apparatus is not unnecessarily increased.

As described above, in this embodiment, the print start position on the left end side is set in accordance with the approach run distance of the print head 2a. Needless to say, the approach run distance of the print head 2b should be established based on this print start position. That is, the distance between the print heads 2a and 2b mounted on the carriage 3 is a value such that the sum of this distance and the approach run distance of the print head 2a should satisfy the approach run distance of the print head 2b.

A second embodiment of the present invention will now be described. An inkjet printing apparatus for this embodiment includes a head maintenance mechanism 9 in addition to the arrangement for the first embodiment. Since the other arrangement for the inkjet printing apparatus, and a control system configuration are the same as those for the first embodiment, and the same processing as shown in the flowchart in FIG. 4 is performed, no further description will be given for them.

In the printing apparatus, the head maintenance mechanism 9 should be located in the main scan direction, outside the region where a printing medium 1 is loaded. Therefore, the inkjet printing apparatus needs to be increased in the main scan direction, by a size equivalent to the space required for installing the head maintenance mechanism 9. Referring to FIGS. 5A and 5B in the first embodiment, a great approach run distance for the carriage 3 is prepared on the right end side (first end side), and the head maintenance mechanism 9 can be arranged on the right end side (first end side) as shown in FIG. 5B. Therefore, an unnecessary increase in the size of the inkjet printing apparatus can be avoided.

As described above, according to this embodiment, for an inkjet printing apparatus that includes the head maintenance mechanism, an unnecessary increase in the apparatus size can be avoided, and vibration of the print head that is relatively apart from the guide shaft can be effectively reduced.

A third embodiment of the present invention will now be described. Since the arrangement for an inkjet printing apparatus and a schematic configuration for a control system for this embodiment are the same as those for the first embodiment, no further description will be given for them. Further, the operation in the flowchart in FIG. 4 is also performed for this embodiment. And an explanation for the processes already described for the first embodiment will not be repeated for this embodiment.

While referring to FIGS. 5A, 5B and 6, an explanation will be given for a method whereby, after the processes at steps S1 to S3 in FIG. 4 have been performed, at step S4 the acceleration for a carriage 3 is set as one of the drive parameters for the carriage 3. The amplitude of the vibration generated by the accelerated movement of the carriage 3 is reduced in accordance with a reduction in the acceleration for the carriage 3, and therefore, the waveform of a print head 2b, indicated by a broken line in FIG. 6, also becomes similar to the waveform of a print head 2a indicated by a solid line by reducing the acceleration. That is, when the carriage 3 moves in the forward scan direction in FIG. 5A, the acceleration for the carriage 3 is set smaller than when the carriage 3 moves in the backward scan direction in FIG. 5B. As a result, as in the first embodiment, the print head that is relatively apart from the guide shaft can be employed for printing in the state wherein the vibration has been appropriately attenuated. At step S5, the drive parameters designated in this manner at step S4 are employed to drive the carriage 3.

According to the method employed in this embodiment, since low acceleration in the forward scan direction is set, the vibration of the print head that is located relatively apart from the guide shaft can be effectively reduced. Since a great approach run distance is not required as in the first embodiment, the employment of this embodiment is effective for a case wherein there is a limitation in the size of the apparatus and degrading of a printing speed, which is caused by lowering the acceleration, is not very significant.

A fourth embodiment of the present invention will now be described. Since the arrangement for an inkjet printing apparatus and a schematic configuration for a control system for this embodiment are the same as those for the first embodiment, no further description will be given for them. Further, the operation in the flowchart in FIG. 4 is also performed for this embodiment. An explanation for the processes already described for the first embodiment will not be repeated for this embodiment.

In this embodiment, an explanation will be given for a case wherein, after the process has been performed at step S1 in FIG. 4, at step S2 a one-way printing mode is selected. The one-way printing mode is selected when acquisition of a higher image quality is more important, while the printing speed is lower than in the two-way printing mode. In this case, referring to FIGS. 5A and 5B, the printing speed for the forward scan direction is lower than the printing speed for the backward scan direction because, as previously described in the first or the third embodiment, the approach run distance is increased, or the acceleration is reduced. Therefore, the backward scan direction is selected to perform one-way printing. The processes at step S3 and the following steps are performed in the same manner as in the first to the third embodiments.

According to the four embodiments above described, two print heads have been employed. However, the present invention is not limited to two print heads, and an arbitrary number of print heads, more than one, can be employed. For example, the arrangement pattern shown in FIG. 2 for the print heads or the nozzle arrays may be repeated to form a staggered pattern of print heads or nozzle arrays. At this time, as well as in FIG. 2, the adjacent print heads partially overlap each other, so that the nozzle arrays in the overlapped portions of the print heads scan the same area. With this arrangement, even when the nozzle arrays of the individual print heads are short, printing can be performed by regarding these print heads as a print head assembly, for which a length in the sub-scan direction is almost equal to the sum of the lengths of the nozzle arrays of the print heads. As a result, high-speed printing is enabled.

The number of nozzles for a print head, the color types of ink and the color arrangement are also not limited to those described in the above embodiments. For example, different ink colors may be employed for the nozzle arrays of the first print head and the nozzle arrays of the second print head, for which the distance from the guide member differs.

The first to the third embodiments may also be combined. That is, a set composed of an approach run distance and an acceleration rate may be selected in accordance with the specifications for the printing apparatus.

The inkjet printing apparatus has been employed as an example for the individual embodiments. However, the present invention is not limited to this type of printing apparatus and can be applied for another type of printing apparatus, where vibration generated during the accelerated movement of a carriage could adversely affect print heads mounted on the carriage and degrade printing.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-191385, filed Aug. 27, 2010, which is hereby incorporated by reference herein in its entirety.

What is claimed is:

1. A printing apparatus having:
a carriage, on which a plurality of print heads including a first print head and a second print head are mounted, movable along a guide between a first end and a second end; and
a control unit configured to control a reciprocation of the carriage when printing is performed onto a print medium,
wherein the plurality of print heads are so arranged that when the carriage is located at the first end, the first print head, relatively apart from the guide, is positioned nearer the print medium than the second print head, located relatively near the guide, and when the carriage is located at the second end, the second print head is positioned nearer the print medium than the first print head, and
wherein a distance from the first print head to the print medium when the carriage is located at the first end is greater than a distance from the second print head to the print medium when the carriage is located at the second end.

2. The printing apparatus according to claim 1, wherein a head maintenance mechanism for performing maintenance for the print heads is provided near the first end.

3. The printing apparatus according to claim 1, wherein the control unit is capable of performing one-way printing according to which printing is performed in a scan direction from the second end to the first end, and printing is not performed in a scan direction from the first end to the second end.

4. The printing apparatus according to claim 1, wherein an acceleration for the carriage employed when the carriage moves from the first end toward the print medium is set lower than an acceleration employed when the carriage moves from the second end toward the print medium.

5. The printing apparatus according to claim 1, wherein the plurality of print heads are inkjet heads.

6. A printing apparatus having:
a carriage, on which a plurality of print heads including a first print head and a second print head are mounted, movable along a guide between a first end and a second end; and
a control unit configured to control a reciprocation of the carriage when printing is performed onto a print medium,
wherein the plurality of print heads are so arranged that when the carriage is located at the first end, the first print head, relatively apart from the guide, is positioned nearer the print medium than the second print head, located relatively near the guide, and when the carriage is located at the second end, the second print head is positioned nearer the print medium than the first print head, and
wherein an acceleration for the carriage, employed when the carriage moves from the first end toward the print medium is lower than an acceleration employed when the carriage moves from the second end toward the print medium.

7. The printing apparatus according to claim 6, wherein the control unit is capable of performing one-way printing, according to which printing is performed in a scan direction from the second end to the first end, and is not performed in a scan direction from the first end to the second end.

8. The printing apparatus according to claim 6, wherein the plurality of print heads are inkjet heads.

9. A method for printing onto a print medium, comprising: reciprocally moving a carriage, on which a plurality of print heads including a first print head and a second print head are mounted, along a guide between a first end and a second end; and
printing using the plurality of print heads, wherein the plurality of print heads are arranged, so that when the carriage is located at the first end, the first print head, relatively apart from the guide, is positioned nearer the print medium than the second print head, located relatively near the guide, and when the carriage is located at the second end, the second print head is positioned nearer the print medium than the first print head; and
a distance from the first print head to the print medium when the carriage is located at the first end is greater than a distance from the second print head to the print medium when the carriage is located at the second end.

10. A method for printing onto a print medium, comprising:
reciprocally moving a carriage, on which a plurality of print heads including a first print head and a second print head are mounted, along a guide between a first end and a second end; and
printing using the plurality of print heads, wherein the plurality of print heads are arranged, so that when the carriage is located at the first end, the first print head, relatively apart from the guide, is positioned nearer the print medium than the second print head, located relatively near the guide, and when the carriage is located at the second end, the second print head is positioned nearer the print medium than the first print head; and
an acceleration for the carriage employed when the carriage moves from the first end toward the print medium is set lower than an acceleration employed when the carriage moves from the second end toward the print medium.
